(19) United States
(12) Patent Application Publication
(10) Pub. No.: US 2025/0309332 A1
(43) Pub. Date: Oct. 2, 2025

(54) LITHIUM METAL SECONDARY BATTERY AND AGING METHOD OF THE SAME

(71) Applicant: HONDA MOTOR CO., LTD., Tokyo (JP)

(72) Inventors: Noritaka KIMURA, Saitama (JP); Kazuki SAIMEN, Saitama (JP); Takeshi FUJINO, Saitama (JP)

(21) Appl. No.: 19/063,327

(22) Filed: Feb. 26, 2025

(30) Foreign Application Priority Data
Mar. 30, 2024 (JP) 2024-058363

(51) Int. Cl. H01M 10/052; H01M 4/02; H01M 4/38; H01M 10/44; H01M 50/46

(52) U.S. Cl. CPC H01M 10/052; H01M 4/382; H01M 10/44; H01M 50/46; H01M 2004/027

(57) ABSTRACT

A lithium metal secondary battery according to an embodiment of the present invention includes an electrode laminate having a positive electrode layer, a separator, and a negative electrode layer laminated in this order and an electrolytic solution, the negative electrode layer is a lithium-containing metal layer, and a plurality of protrusions are disposed on a surface of the separator on a side of the negative electrode layer or on a surface of the negative electrode layer on a side of the separator.

This application is based on and claims the benefit of priority from Japanese Patent Application No. 2024-058363, filed on 30 Mar. 2024, the content of which is incorporated herein by reference.

### BACKGROUND OF THE INVENTION

### Field of the Invention

The present invention relates to a lithium metal secondary battery and an aging method of the same.

### Related Art

In recent years, research and development have been conducted on secondary batteries that contribute to energy efficiency in order to enable more people to secure access to affordable, reliable, sustainable, and advanced energy. As such a secondary battery, a lithium secondary battery is known which is configured such that a compound containing lithium is used as a positive electrode active material of a positive electrode layer, lithium ions are moved from the positive electrode active material to a negative electrode layer during charging, and the lithium ions are moved from the negative electrode layer to the positive electrode active material during discharging. In the lithium secondary battery having such a configuration, since the lithium is in the positive electrode active material immediately after manufacture, it is common to perform aging including a charging process (Patent Document 1).
Patent Document 1: Japanese Unexamined Patent Application, Publication No. 2024-500687

### SUMMARY OF THE INVENTION

Now, in technology regarding secondary batteries, one problem is to shorten aging time. As a lithium secondary battery, a lithium metal secondary battery is known in which a lithium-containing metal layer is used as a negative electrode layer and lithium ions are deposited on the lithium-containing metal layer during charging to generate a lithium metal layer. However, according to studies by the present inventors, in the lithium metal secondary battery, when a high-concentration electrolytic solution having an electrolyte concentration of 1.0 to 2.5 mol/L is used, it is difficult for the electrolytic solution to move to a lithium metal negative electrode surface after a separator sufficiently holds the electrolytic solution first, and it takes a long time for an entire surface of a negative electrode to be sufficiently wetted with the electrolytic solution. In particular, the high-concentration electrolytic solution has been studied for a large-sized lithium metal secondary battery for in-vehicle use, and it is difficult to shorten the aging time.

The present invention is implemented in consideration of the above, and an object is to provide a lithium metal secondary battery and an aging method of the lithium metal secondary battery that can shorten aging time. Accordingly, the present invention contributes to energy efficiency.

In order to solve the problem, the present inventors have found that it is effective to dispose a plurality of protrusions on a surface of a separator of a lithium metal secondary battery on a side of a negative electrode layer or on a surface of the negative electrode layer on a side of the separator, and have completed the present invention. Therefore, the present invention provides the following.

A first aspect of the present invention relates to a lithium metal secondary battery including: an electrode laminate having a positive electrode layer, a separator, and a negative electrode layer laminated in this order; and an electrolytic solution, in which the negative electrode layer is a lithium-containing metal layer, and a plurality of protrusions are disposed on a surface of the separator on a side of the negative electrode layer or on a surface of the negative electrode layer on a side of the separator.

According to the lithium metal secondary battery as described in the first aspect, since a gap is formed between the separator and the negative electrode layer by the protrusions, a lithium negative electrode is wetted first in advance and then the electrolytic solution moves to the separator so that it is possible to make the electrolytic solution permeate into both of the separator and the negative electrode layer. Therefore, time for a lithium metal negative electrode to be sufficiently wetted with the electrolytic solution can be made shorter than before. Thus, retention time after the electrolytic solution is injected can be shortened and total aging time can be shortened.

A second aspect of the present invention relates to the lithium metal secondary battery as described in the first aspect, in which the protrusions are disposed on the surface of the separator on the side of the negative electrode layer.

According to the lithium metal secondary battery as described in the second aspect, since the protrusions are formed on the surface of the separator on the side of the negative electrode layer, wettability of the negative electrode layer is improved. Thus, a negative electrode potential is stabilized. After the negative electrode potential is stabilized, when the lithium metal secondary battery is restrained, the protrusions are crushed and the gap disappears. When initial charging is performed in the restrained state and lithium ions are deposited on a negative electrode, bonding of lithium foil and deposited lithium becomes strong. Therefore, characteristics during discharging are improved.

A third aspect of the present invention relates to the lithium metal secondary battery as described in the second aspect, in which the separator includes a functional layer on the surface on the side of the negative electrode layer, and the protrusions are disposed on a surface of the functional layer.

According to the lithium metal secondary battery as described in the third aspect, by providing the functional layer on the surface of the separator on the side of the negative electrode layer, the characteristics of the lithium metal secondary battery can be further improved.

A fourth aspect of the present invention relates to the lithium metal secondary battery as described in any one of the first to third aspects, in which the protrusions have an average diameter within a range of 100 μm or more and 300 μm or less, and an average height within a range of 0.5 μm or more and 1.5 μm or less.

According to the lithium metal secondary battery as described in the fourth aspect, since the average diameter and the average height of the protrusions are within the ranges described above, the gap into which the electrolytic solution can permeate can be more stably formed between the separator and the negative electrode layer. Therefore, permeation time of the electrolytic solution becomes shorter.

A fifth aspect of the present invention relates to the lithium metal secondary battery as described in any one of the first to fourth aspects, in which an average interval between the protrusions adjacent to each other is within a range of 100 μm or more and 1 mm or less.

According to the lithium metal secondary battery as described in the fifth aspect, since the average interval of the protrusions is within the range described above, the gap into which the electrolytic solution can permeate can be further stably formed between the separator and the negative electrode layer. Therefore, the permeation time of the electrolytic solution becomes even shorter.

A sixth aspect of the present invention relates to the lithium metal secondary battery according to any one of the first to fifth aspects, in which an area occupancy ratio of the protrusions is within a range of 5% or higher and 10% or lower.

According to the lithium metal secondary battery as described in the sixth aspect, since the area occupancy ratio of the protrusions is within the range described above, the lithium ions are uniformly charged without dispersion and thus durability can be improved. Further, in a case where the protrusions are formed of a resin having solubility in the electrolytic solution, since a dissolution speed of the protrusions into the electrolytic solution is accelerated, it is less likely that the resin remains between the negative electrode layer and the separator and the negative electrode layer and the separator are unevenly coated with the resin.

A seventh aspect of the present invention relates to an aging method of the lithium metal secondary battery according to any one of the first to sixth aspects, the method including a step of performing charging in a state where the lithium metal secondary battery is disposed such that a surface of the separator is along a gravity direction.

According to the aging method of the lithium metal secondary battery as described in the seventh aspect, since the lithium metal secondary battery is disposed such that the surface of the separator is along the gravity direction, the electrolytic solution permeates between the separator and the negative electrode layer via the gap formed by the protrusions due to a capillary phenomenon. Therefore, since the wettability of the negative electrode layer becomes uniform and a potential of the negative electrode layer becomes uniform, impregnation retention time becomes short. Therefore, a charging rate in aging can be increased. Thus, according to the aging method of the lithium metal secondary battery, aging time can be shortened.

According to the present invention, it is possible to provide a lithium metal secondary battery and an aging method of the lithium metal secondary battery that can shorten aging time.

### BRIEF DESCRIPTION OF THE DRAWINGS

FIG. 1 is a sectional view illustrating a lithium metal secondary battery according to an embodiment of the present invention; and

FIG. 2 is an enlarged sectional view in which a part A in FIG. 1 is enlarged.

### DETAILED DESCRIPTION OF THE INVENTION

Hereinafter, an embodiment of the present invention will be described with reference to the drawings. Note that the embodiment described below exemplifies the present invention and the present invention is not limited thereto.

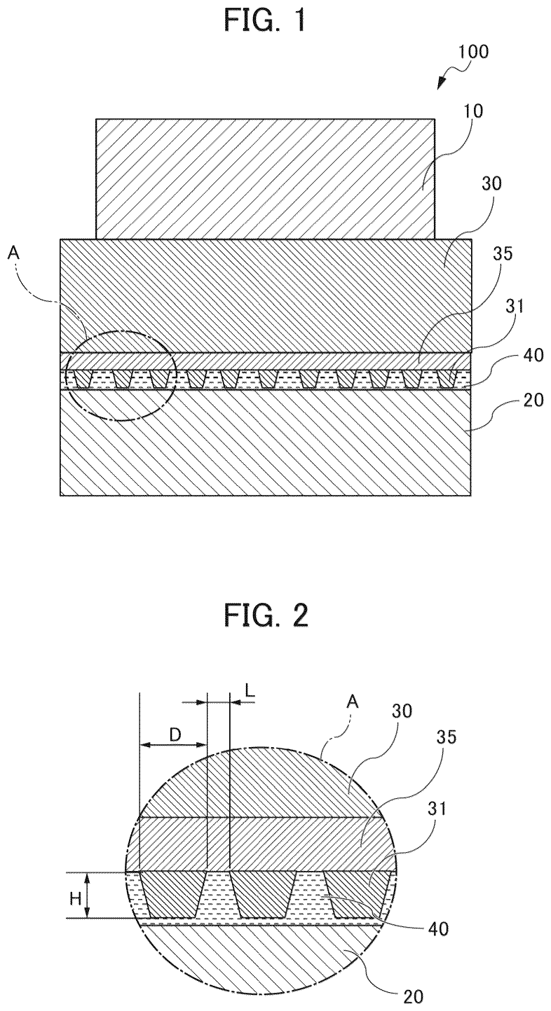

FIG. 1 is a sectional view illustrating a lithium metal secondary battery according to an embodiment of the present invention. FIG. 2 is an enlarged sectional view in which a part A in FIG. 1 is enlarged.

As illustrated in FIG. 1 and FIG. 2, a lithium metal secondary battery 100 includes: an electrode laminate 40 having a positive electrode layer 10, a separator 20, and a negative electrode layer 30 laminated in this order; and an electrolytic solution 50. On a surface of the positive electrode layer 10 on a side opposite to the side of the separator 20, a positive electrode collector (not shown) is disposed. On a surface of the negative electrode layer 30 on the side opposite to the side of the separator 20, a negative electrode collector (not shown) is disposed. The electrode laminate 40 and the electrolytic solution 50 are housed in an exterior body (not shown). The exterior body includes a positive electrode tab connected to the positive electrode collector, and a negative electrode tab connected to the negative electrode collector.

The positive electrode layer 10 contains a positive electrode active material. As the positive electrode active material, a compound containing lithium can be used. Examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), a different element-substituted Li—Mn spinel represented by Li₁₊ₓMn_{2-x-y}M_{y}O₄ (x+y=2, M=at least one kind selected from Al, Mg, Co, Fe, Ni, and Zn), lithium titanate (oxide containing Li and Ti), and lithium metal phosphate (LiMPO₄, M=at least one kind selected from Fe, Mn, Co, and Ni). The positive electrode layer 10 may contain various kinds of additives used as materials of the positive electrode layer, such as a binder and a conductive auxiliary agent.

The separator 20 includes a functional layer 25 on the surface on the side of the negative electrode layer 30, and protrusions 21 are disposed on the surface of the functional layer 25.

The separator 20 is not limited in particular, and a known separator used as a separator of a lithium metal secondary battery, such as a porous body sheet and a nonwoven fabric sheet, can be used. Examples of a material of the porous body sheet include polyolefin such as polyethylene and polypropylene, aramid, polyimide, and fluororesin. Examples of a material of the nonwoven fabric sheet include glass fibers and cellulose fibers. A film thickness of the separator 20 is not limited in particular, and may be within a range of 10 μm or more and 15 μm or less, or within a range of 10 μm or more and 12 μm or less, for example.

The functional layer 25 may be a conductive layer having conductivity for example. When the functional layer 25 is a conductive layer, electrons are supplied to the side of the functional layer 25 during charging, and nucleation of the lithium is accelerated in the functional layer 25. Thus, a short circuit by dendrite and decline of a density of an active material layer of the negative electrode layer in a charging state can be suppressed. Electrical conductivity of the conductive layer may be within a range of 1.0×10¹ S/cm or higher and 1.0×10⁵ S/cm or lower, for example. Surface resistivity of the conductive layer may be 200 Ω/cm² or lower. As a material of the conductive layer, a conductive material such as metal and a carbon nanotube (CNT) can be used for example. Examples of the metal include Cu, Zn, Ti and Sn. For these conductive materials, one kind may be used alone, or two or more kinds may be used in combination.

The protrusions 21 have a function of forming a gap between the separator 20 and the negative electrode layer 30 and making it easy for the electrolytic solution 50 to permeate between the separator 20 and the negative electrode layer 30. A shape of the protrusions 21 is not limited in particular, and may be a columnar shape, a granular shape, or a cross-sectionally trapezoidal shape for example.

A diameter (D in FIG. 2) of the protrusions 21 is not limited in particular, and an average diameter may be within a range of 100 μm or more and 300 μm or less. A height (H in FIG. 2) of the protrusions 21 is not limited in particular, and an average height may be within a range of 50 nm or more and 3 μm or less or may be within a range of 0.5 μm or more and 1.5 μm or less. When the average diameter and the average height of the protrusions 21 are within the ranges described above, the gap into which the electrolytic solution 50 can permeate can be more stably formed between the separator 20 and the negative electrode layer 30.

An interval (L in FIG. 2) of the protrusions 21 adjacent to each other is not limited in particular, and an average interval may be within a range of 100 μm or more and 1 mm or less. The interval of the protrusions 21 is a distance between the protrusion 21 and the protrusion 21 at a position closest to that protrusion 21. When the average interval of the protrusions 21 is within the range described above, the gap into which the electrolytic solution 50 can permeate can be more stably formed between the separator 20 and the negative electrode layer 30.

An area occupancy ratio of the protrusions 21 is not limited in particular, and may be within a range of 5% or higher and 10% or lower. The area occupancy ratio of the protrusions 21 is a percentage of area occupied by the protrusions 21 in relation to surface area of the separator 20. When the area occupancy ratio of the protrusions 21 is within the range described above, the gap into which the electrolytic solution easily permeates can be formed while maintaining the conductivity of lithium ions between the separator 20 and the negative electrode layer 30.

The average diameter, the average height, the average interval and the area occupancy ratio of the protrusions 21 can be measured by surface observation of the separator 20 by an SEM (scanning electron microscope).

A material of the protrusions 21 is not limited in particular, and resin, metal, carbon and ceramics can be used for example. Examples of the resin include PVDF, polyethylene (PE), polypropylene (PP), polyethylene glycol (PEG), polyethylene oxide (PEO), and acrylic resin. The resin may be gradually dissolved in the electrolytic solution 50. By dissolution of the protrusions 21, a distance between the separator 20 and the negative electrode layer 30 is fixed. In addition, after the negative electrode layer 30 is sufficiently wetted with the electrolytic solution 50, the lithium metal secondary battery 100 may be temporarily heated in order to accelerate the dissolution of the protrusions 21. A material of the protrusions 21 may be same as the material of the functional layer 25.

As a method of forming the protrusions 21 on the separator 20, a sputtering method or a coating method can be used for example. The coating method is a method of coating and drying dispersion liquid in which material particles of the protrusions 21 are dispersed on a surface of the separator 20 in a pattern shape. As a dispersion liquid coating method, a gravure method can be used for example.

The negative electrode layer 30 is a lithium-containing metal layer. The lithium-containing metal layer is formed of the lithium alone or lithium alloy. The lithium alloy contains metal that forms alloy with the lithium. Examples of the metal that forms the alloy with the lithium include Mg, Au, Ag, In, Ge, Sn, Pb, Al, and Zn.

The electrolytic solution 50 contains an organic solvent and an electrolyte. As the organic solvent, for example, cyclic carbonate, chain carbonate, cyclic ether, chain ether, hydrofluoroether, aromatic ether, sulfone, cyclic ester, chain carboxylic ester, and nitrile can be used. Examples of the cyclic carbonate include ethylene carbonate, propylene carbonate, vinylene carbonate, and fluoroethylene carbonate. Examples of the chain carbonate include dimethyl carbonate, diethyl carbonate, and ethyl methyl carbonate. Examples of the cyclic ether include tetrahydrofuran, 2-methyltetrahydrofuran, tetrahydropyran, 1,3-dioxolan, and 4-methyl 1,3-dioxolan. Examples of the chain ether include 1,2-dimethoxyethane, 1,2-diethoxyethane, ethoxymethoxyethane, and diethyl ether. Examples of the hydrofluoroether include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, and 1,2-bis(1,1,2,2-tetrafluoroethoxy) ethane. An example of the aromatic ether is anisole. Examples of the sulfone include sulfolane and methylsulfolane. An example of the cyclic ester is γ-butyrolactone. Examples of the chain carboxylic ester include acetate, butyrate, and propionate. Examples of the nitrile include acetonitrile and propionitrile. For the organic solvent, one kind may be used alone, or two or more kinds may be used in combination.

The electrolyte is a supply source of the lithium ions that are charge transfer media, and contains lithium salt. Examples of the lithium salt include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), and LiBC₄O₈. For the lithium salt, one kind may be used alone, or two or more kinds may be used in combination. A concentration of the electrolyte may be within a range of 1.0 to 4.0 mol/L for example, or may be within a range of 1.0 to 2.5 mol/L.

An aging method of the lithium metal secondary battery 100 of the present embodiment includes, for example, a step of making the lithium metal secondary battery 100 stand still and making the electrolytic solution 50 permeate between the separator 20 and the negative electrode layer 30 (hereinafter, this step is sometimes referred to as a standing step), and an initial charging step of charging the lithium metal secondary battery 100 after the standing step.

In the standing step, the lithium metal secondary battery 100 is preferably disposed such that the surface of the separator 20 is along a gravity direction, that is, a lamination direction of the electrode laminate 40 is perpendicular to the gravity direction. When the lithium metal secondary battery 100 is made to stand still in a state of being disposed in such a manner, the electrolytic solution 50 is accumulated at a lower part in the gravity direction of the lithium metal secondary battery 100. When the separator 20 contacts the electrolytic solution 50 accumulated at the lower part in the gravity direction, the electrolytic solution 50 permeates between the separator 20 and the negative electrode layer 30 through the gap formed by the protrusions 21 due to a capillary phenomenon. Therefore, permeation time for the electrolytic solution 50 to sufficiently permeate between the separator 20 and the negative electrode layer 30 can be shortened.

In the standing step, a load may be imparted in the lamination direction of the electrode laminate 40 of the lithium metal secondary battery 100. The load to be imparted may be within a range of 0.001 MPa or more and 0.05 MPa or less for example. Stand-still time of the lithium metal secondary battery 100 in the standing step may be within five hours for example.

In the initial charging step, similarly to the standing step, the lithium metal secondary battery 100 is disposed such that the surface of the separator 20 is along the gravity direction. By performing initial charging in the state where the lithium metal secondary battery 100 is disposed in such a manner, it becomes easy for the electrolytic solution 50 to permeate between the separator 20 and the negative electrode layer 30 via the gap formed by the protrusions 21 due to the capillary phenomenon since the separator 20 contacts the electrolytic solution 50 accumulated at the lower part in the gravity direction. Therefore, an amount of the electrolytic solution 50 between the separator 20 and the negative electrode layer 30 is large. Therefore, a charging rate in the initial charging step can be increased. The charging rate may be within a range of 0.05 C or higher and 0.3 C or lower for example.

In the initial charging step, a load may be imparted in the lamination direction of the electrode laminate 40 of the lithium metal secondary battery 100. By imparting the load, internal resistance of the lithium metal secondary battery 100 is lowered and thus the charging rate can be increased. The load to be imparted may be within a range of 0.001 MPa or more and 0.11 MPa or less for example.

According to the lithium metal secondary battery 100 of the present embodiment configured as above, since the protrusions 21 are disposed on the surface of the separator 20 on the side of the negative electrode layer 30 and the gap is formed between the separator 20 and the negative electrode layer 30 by the protrusions 21, it is easy for the electrolytic solution 50 to permeate between the separator 20 and the negative electrode layer 30. Therefore, the permeation time for the electrolytic solution 50 to sufficiently permeate between the separator 20 and the negative electrode layer 30 from immediately after the lithium metal secondary battery 100 is manufactured becomes short. Thus, aging time can be shortened. In addition, since the protrusions are formed on the surface of the separator 20 on the side of the negative electrode layer 30, wettability of the negative electrode layer 30 is improved. Even after the lithium ions are deposited on the negative electrode layer 30 by charging, the gap formed between the separator 20 and the negative electrode layer 30 is maintained. Thus, a characteristic during discharging is also improved. Further, since the lithium metal secondary battery 100 of the present embodiment includes the functional layer 25 on the surface on the side of the negative electrode layer 30, the characteristic of the lithium metal secondary battery 100 can be further improved.

According to the aging method of the lithium metal secondary battery 100 of the present embodiment, since the lithium metal secondary battery 100 of the present embodiment is disposed such that the surface of the separator 20 is along the gravity direction, it is easy for the electrolytic solution 50 to permeate between the separator 20 and the negative electrode layer 30. Therefore, the permeation time of the electrolytic solution 50 becomes short. In addition, the amount of the electrolytic solution 50 between the separator 20 and the negative electrode layer 30 increases. Therefore, the charging rate in the initial charging step can be increased. Thus, according to the aging method of the lithium metal secondary battery 100 of the present embodiment, the aging time can be shortened.

The embodiment of the present invention has been described above, but the present invention is not limited to the above embodiment. For example, while the protrusions 21 are disposed on the separator 20 in the lithium metal secondary battery 100 of the present embodiment, a disposition position of the protrusions 21 is not limited thereto. The protrusions 21 may be disposed on the surface of the negative electrode layer 30 on the side of the separator 20.

While the standing step is conducted in the aging method of the lithium metal secondary battery 100 of the present embodiment, the standing step may be omitted if the electrolytic solution 50 has sufficiently permeated between the separator 20 and the negative electrode layer 30 immediately after the lithium metal secondary battery 100 is manufactured.

### EXAMPLES

Hereinafter, the present invention will be described in more detail with examples. The present invention is not limited to contents of the examples below.

### Example 1

(Production of Separator with Protrusions)

A porous separator made of polyolefin and resin particle dispersion liquid for which resin particles are dispersed in a solvent were prepared. A surface of the porous separator was subjected to corona treatment. A separator with protrusions was produced by pattern-coating the resin particle dispersion liquid on the corona-treated surface of the porous separator using the gravure method and then drying it.

### (Production of Positive Electrode)

Acetylene black (AB) as an electron conductive material, polyvinylidene fluoride (PVDF) as a binding agent (binder), and polyvinylpyrrolidone (PVP) as a dispersing agent were premixed in N-methyl-2-pyrrolidone (NMP) as a dispersion solvent and were wet-mixed in a rotating and revolving mixer to obtain premixed slurry. Subsequently, Li1Ni_{0.8}Co_{0.1}Mn_{0.1}O₂ (NCM811) as the positive electrode active material and the obtained premixed slurry were mixed and dispersion treatment was conducted using a planetary mixer to obtain positive electrode paste. A median diameter of the NCM811 is 12 μm. Next, the obtained positive electrode paste was coated and dried on a positive electrode collector made of aluminum, pressurized by roll pressing, and then dried in vacuum at 120° C. to form a positive electrode plate containing a positive electrode active material layer. The obtained positive electrode plate was punched into a size of 30 mm×40 mm to obtain a positive electrode.

### (Production of Negative Electrode)

A clad material for which copper foil (a negative electrode collector, electric conductivity: 6.5×10⁶ S/cm) having a thickness of 10 μm and lithium foil (a negative electrode layer) having a thickness of 20 μm were bonded was prepared. The clad material was punched into a size of 34 mm×44 mm to obtain a negative electrode.

### (Production of Electrolytic Solution)

The electrolytic solution for which LiFSI was dissolved in 1,2-dimethoxyethane (DME) at a concentration of 4 mol/L was prepared.

### (Production of Lithium Metal Secondary Battery)

The surface of the separator with the protrusions on the side of the protrusions was piled up on the negative electrode layer (lithium foil) of the negative electrode and a positive electrode mixture layer of the positive electrode is piled up on the surface of the separator on the side opposite to the side of the protrusions to produce an electrode laminate for which the negative electrode, the separator, and the positive electrode were laminated in this order. Then, a tab was attached to each of the positive electrode collector and the negative electrode collector of the obtained electrode laminate. The electrode laminate to which the tabs were attached was put in a bag made of a laminate film, the electrolytic solution was put in next, and the bag made of the laminate film was sealed to produce the lithium metal secondary battery.

### Examples 2 and 3

The lithium metal secondary battery was produced similarly to the example 1 except that acrylic resin particle dispersion liquid was coated in a different pattern.

### Example 4

The lithium metal secondary battery was produced similarly to the example 1 except that a separator with protrusions including a functional layer was used as the separator with the protrusions. Note that the separator with the protrusions including the functional layer was produced as follows.

On one surface of a porous separator made of polyolefin, a copper conductive porous layer having a thickness of 0.08 μm was formed by an RF sputtering method. Then, after the surface of the copper conductive porous layer was subjected to the corona treatment, the resin particle dispersion liquid was pattern-coated using the gravure method and then dried.

### Comparative Example 1

The lithium metal secondary battery was produced similarly to the example 1 except that a commercially available separator was used instead of the separator with the protrusions.

### Evaluation

### (Separator)

(Property Evaluation of Protrusions of Separator with Protrusions)

The surfaces of the separators with the protrusions produced in the examples 1 to 4 were observed using an SEM, and an average diameter, an average height, an average interval and an area occupancy ratio were measured. The result is shown in Table 1 below. Note that the average diameter, the average height, and the average interval were values measured for 100 protrusions.

TABLE 1

| | Shape of Protrusion | | | | Presence/ |
|---|---|---|---|---|---|
| | Average | Average | Average | Area | Absence of |
| | Diameter | Interval | Height | Occupancy | Functional |
| | (μm) | (μm) | (μm) | Ratio (%) | Layer |
| Example 1 | 200 | 1.5 | 500 | 10 | No |
| Example 2 | 283 | 1.5 | 500 | 20 | No |
| Example 3 | 346 | 1.5 | 500 | 30 | No |
| Example 4 | 200 | 1.5 | 500 | 10 | Yes |

### (Aging Evaluation)

For the lithium metal secondary batteries produced in the examples 1 to 4 and the comparative example 1, the standing step and the initial charging step were conducted under conditions shown in Table 2 below. In the initial charging step, charging was conducted to 4.30 V at 0.1 C. In comparative examples 1-1, 1-2, and 1-3, the lithium metal secondary battery produced in the comparative example 1 was used and conditions of the standing step and the initial charging step were changed. In a reference example 1, the lithium metal secondary battery produced in the example 4 was used and the conditions of the standing step and the initial charging step were changed. “Longitudinal” for battery disposition in Table 2 means that the lithium metal secondary battery was disposed such that the surface of the separator was along the gravity direction, and “lateral” means that the lithium metal secondary battery was disposed such that the surface of the separator was orthogonal to the gravity direction. Aging evaluation was conducted on 56 lithium metal secondary batteries.

For the lithium metal secondary batteries after the initial charging step, an OCV (circuit voltage) was measured, and the variation coefficient was calculated. The result is shown in Table 2. Note that the OCV variation coefficient is preferably 0.30% or less.

For the lithium metal secondary batteries after the initial charging step, those in which the voltage after aging dropped to around 1.9 V after six hours were defined as defective products, the others were defined as non-defective products, and a ratio of the non-defective products to a total number of the lithium metal secondary batteries subjected to the aging evaluation was calculated as a yield ratio. The result is shown in Table 2. The yield ratio is preferably 0.9 or higher.

The lithium metal secondary batteries after the initial charging step were discharged to 2.65 V at a discharging rate of 1 C. A ratio of discharging capacity to charging capacity in the initial charging step was calculated, and it was defined as initial capacity. The result is shown in Table 2.

TABLE 2

| | | | | Condition of Initial | | | | |
|---|---|---|---|---|---|---|---|---|
| | Condition of Standing Step | | | Charging Step | | Evaluation Result | | |
| | Battery | | Stand-Still | Battery | | OCV Variation | Yield | Initial |
| | Load | Battery | Time | Load | Battery | Coefficient | Ratio | Capacity |
| | (MPa) | Disposition | (Hours) | (MPa) | Disposition | (%) | (—) | (%) |
| Example 1 | 0.01 | Longitudinal | 5.00 | 0.05 | Longitudinal | 0.07 | 1 | 100.0 |
| Example 2 | 0.01 | Longitudinal | 5.00 | 0.05 | Longitudinal | 0.08 | 1 | 99.8 |
| Example 3 | 0.01 | Longitudinal | 5.00 | 0.05 | Longitudinal | 0.10 | 1 | 99.6 |
| Example 4 | 0.01 | Longitudinal | 5.00 | 0.05 | Longitudinal | 0.12 | 0.9 | 99.4 |
| Comparative | 0.01 | Lateral | 48.00 | 0.05 | Lateral | 0.10 | 0.9 | 99.6 |
| Example 1-1 | | | | | | | | |
| Comparative | 0.01 | Lateral | 5.00 | 0.05 | Lateral | 0.34 | 0.5 | 99.0 |
| Example 1-2 | | | | | | | | |
| Comparative | 0.01 | Longitudinal | 5.00 | 0.05 | Longitudinal | 0.72 | 0.3 | 99.2 |
| Example 1-3 | | | | | | | | |
| Reference | 0.01 | Lateral | 5.00 | 0.05 | Lateral | 0.60 | 0.7 | 99.4 |
| Example 1 | | | | | | | | |

From the results in Table 2, in the examples 1 to 4 in which the lithium metal secondary battery with the protrusions disposed on the surface of the separator on the side of the negative electrode layer was disposed such that the surface of the separator was orthogonal to the gravity direction and the aging was conducted, it was confirmed that the OCV variation coefficient was low and the yield ratio and the initial capacity were high in the battery after the aging even when the stand-still time of the battery in the standing step was as short as five hours. In contrast, for the lithium metal secondary battery using the separator not including the protrusions, when the stand-still time of the battery in the standing step was increased to 48 hours, the OCV variation coefficient was low and the yield ratio and the initial capacity were high similarly to the examples 1 to 4 in the battery after the aging (the comparative example 1-1). However, when the stand-still time of the battery in the standing step was shortened to five hours, the OCV variation coefficient rose and the yield ratio decreased in the battery after the aging (the comparative example 1-2, the comparative example 1-3). This is because that the electrolytic solution did not sufficiently permeate between the separator and the negative electrode layer. Further, even for the lithium metal secondary battery with the protrusions disposed on the surface of the separator on the side of the negative electrode layer, when it was disposed such that the surface of the separator was orthogonal to the gravity direction and the stand-still time of the battery in the standing step was five hours, it was confirmed that the OCV variation coefficient rose and the yield ratio decreased in the battery after the aging (the reference example 1).

### EXPLANATION OF REFERENCE NUMERALS

10 positive electrode layer
20 separator
21 protrusion
25 functional layer
30 negative electrode layer
40 electrode laminate
50 electrolytic solution
100 lithium metal secondary battery

What is claimed is:

1. A lithium metal secondary battery comprising: an electrode laminate having a positive electrode layer, a separator, and a negative electrode layer laminated in this order; and an electrolytic solution,
wherein the negative electrode layer is a lithium-containing metal layer, and
a plurality of protrusions are disposed on a surface of the separator on a side of the negative electrode layer or on a surface of the negative electrode layer on a side of the separator.

2. The lithium metal secondary battery according to claim 1, wherein the protrusions are disposed on the surface of the separator on the side of the negative electrode layer.

3. The lithium metal secondary battery according to claim 2, wherein the separator includes a functional layer on the surface on the side of the negative electrode layer, and the protrusions are disposed on a surface of the functional layer.

4. The lithium metal secondary battery according to claim 1, wherein the protrusions have an average diameter within a range of 100 μm or more and 300 μm or less, and an average height within a range of 0.5 μm or more and 1.5 μm or less.

5. The lithium metal secondary battery according to claim 1, wherein an average interval between the protrusions adjacent to each other is within a range of 100 μm or more and 1 mm or less.

6. The lithium metal secondary battery according to claim 1, wherein an area occupancy ratio of the protrusions is within a range of 5% or higher and 10% or lower.

7. An aging method of the lithium metal secondary battery according to claim 1,
the method comprising a step of performing charging in a state where the lithium metal secondary battery is disposed such that a surface of the separator is along a gravity direction.
